(19) United States
(12) Patent Application Publication
(10) Pub. No.: US 2020/0175044 A1
(43) Pub. Date: Jun. 4, 2020

(54) LOCATION BASED ALERTS OF SATELLITE DERIVED PRODUCTS

(71) Applicant: Geo ThinkTank LLC, Washington, DC (US)

(72) Inventor: Francis Padula, Alexandria, VA (US)

(21) Appl. No.: 16/699,609

(22) Filed: Nov. 30, 2019

Related U.S. Application Data
(60) Provisional application No. 62/773,702, filed on Nov. 30, 2018.

(51) Int. Cl. G06F 16/29; G01R 29/08; H04W 4/02; H04W 4/021; H04W 4/90; H04L 9/32; H04L 29/08; H04W 68/00

(52) U.S. Cl. CPC G06F 16/29; G01R 29/0842; H04W 4/023; H04W 68/005; H04W 4/90; H04L 9/3213; H04L 67/26; H04W 4/021

(57) ABSTRACT

A method, computer program product, and a system where a processor(s) obtains, via a satellite sensor which continuously observes an Earth scene, geospatial product(s) (satellite derived event(s). The processor(s) associates each geospatial product with a location defined by a reference on a coordinate system. The processor(s) determines a current location of a client device on the coordinate system. The processor(s) generates proximity values to indicate a proximity of the current location to each geospatial product. The processor(s) determines if the proximity values predefined proximity thresholds and if a proximity thresholds is met or exceeded by at least one proximity value, the processor(s) generates a notification for the client device, an alert regarding a geospatial products(s). The processor(s) transmits the alert to the client device and generates an instant alert visually disrupting any application displaying on the client device.

### FIELD OF INVENTION

The present invention relates to the notification of users of mobile applications and/or geospatial web-enabled technology, in real-time to near real-time, to their proximity to environmental hazards or events of interest based upon satellite derived geospatial data products—providing environmental intelligence to users.

### BACKGROUND OF INVENTION

A large percentage of the population today gets its short-term weather and environmental information via a personal computing device, including but not limited to forecast on their phone, or a portable computing device like an iPad or a laptop. After all, it doesn't get any easier. The utility of many of these applications has been criticized based on how the data that the applications is provided and used to warn of upcoming events. For example, ground networks for lightning provide primarily a point-based observation of lightning flashes. Since, lightning can and does travel many miles from its point of origin (these flashes can also come to ground) the ground network data is limited in the assessment of the spatial extent of the flash. Another example, being when an application or news outlet warns of a wildfire, it can be very challenging for the public to understand if they are in harm's way based on their current location and the location of the wildfire.

### SUMMARY OF INVENTION

Shortcomings of the prior art are overcome and additional advantages are provided through the provision of a method to provide geospatially aware user notifications to users utilizing satellite derived geospatial products to provide the geospatially aware user notifications. The method includes: obtaining, by one or more processors, via a satellite sensor which continuously observes an Earth scene, one or more a geospatial products, wherein each geospatial product comprises a satellite derived event; associating, by the one or more processors, each of the one or more geospatial products with a location defined by a reference on a coordinate system; contemporaneously with obtaining the geospatial products, determining, by the one or more processors, based on a token obtained by the one or more processors from a client device, a current location of the client device, wherein the current location is defined by a given reference on the coordinate system; generating, by the one or more processors, based on the current location and the location associated with each of the one or more geospatial products, proximity values, wherein each proximity value indicates a proximity of the current location to a geospatial product of the one or more geospatial products; determining, by the one or more processors, if any of the proximity values are within one or more predefined proximity thresholds, wherein the proximity thresholds are stored on a memory device communicatively couples to the one or more processors; based on determining that at least one of the proximity thresholds is met or exceeded by at least one proximity value of the proximity values, generating a notification for the client device comprising an alert regarding the one or more geospatial products associated with the at least one proximity value; transmitting, by the one or more processors, the alert to the client device; and generating, by the one or more processors, an instant alert in a graphical user interface on the client device, wherein the instant alert visually disrupts any application displaying on the client device.

Shortcomings of the prior art are also overcome and additional advantages are provided through the provision of a system to provide geospatially aware user notifications to users utilizing satellite derived geospatial products to provide the geospatially aware user notifications. The system includes: one or more processors in communication with the memory; program instructions executable by the one or more processors via the memory to perform a method, the method comprising: obtaining, by the one or more processors, via a satellite sensor which continuously observes an Earth scene, one or more a geospatial products, wherein each geospatial product comprises a satellite derived event; associating, by the one or more processors, each of the one or more geospatial products with a location defined by a reference on a coordinate system; contemporaneously with obtaining the geospatial products, determining, by the one or more processors, based on a token obtained by the one or more processors from a client device, a current location of the client device, wherein the current location is defined by a given reference on the coordinate system; generating, by the one or more processors, based on the current location and the location associated with each of the one or more geospatial products, proximity values, wherein each proximity value indicates a proximity of the current location to a geospatial product of the one or more geospatial products; determining, by the one or more processors, if any of the proximity values are within one or more predefined proximity thresholds, wherein the proximity thresholds are stored on a memory device communicatively couples to the one or more processors; based on determining that at least one of the proximity thresholds is met or exceeded by at least one proximity value of the proximity values, generating a notification for the client device comprising an alert regarding the one or more geospatial products associated with the at least one proximity value; transmitting, by the one or more processors, the alert to the client device; and generating, by the one or more processors, an instant alert in a graphical user interface on the client device, wherein the instant alert visually disrupts any application displaying on the client device.

Systems and methods relating to one or more aspects of the technique are also described and may be claimed herein. Further, services relating to one or more aspects of the technique are also described and may be claimed herein.

Additional features are realized through the techniques of the present invention. Other embodiments and aspects of the invention are described in detail herein and are considered a part of the claimed invention.

### BRIEF DESCRIPTION OF DRAWINGS

One or more aspects of the present invention are particularly pointed out and distinctly claimed as examples in the claims at the conclusion of the specification. The foregoing and objects, features, and advantages of one or more aspects of the invention are apparent from the following detailed description taken in conjunction with the accompanying drawing.

FIG. 1 is a workflow that illustrates certain aspects of some embodiments of the present invention.

FIG. 2 is a workflow that illustrates certain aspects of some embodiments of the present invention.

FIG. 3 is an illustration of a technical environment 300 into which aspects of some embodiments of the present invention can be implemented.

FIG. 4 is a schematic illustration of an example of a web-enabled geospatial mobile application in accordance with certain aspects of some embodiments of the present invention.

FIG. 5 is a schematic illustration of an example web-enabled geospatial mobile application in accordance with certain aspects of some embodiments of the present invention.

FIG. 6 is a combination workflow and technical environment that further illustrates certain aspects of some embodiments of the present invention.

FIG. 7 illustrates data from the National Oceanic and Atmospheric Administration (NOAA) Geostationary Lightning Mapper (GLM) on the GOES-16 satellite as displayed in a screen of a graphical user interface (GUI) of an embodiment of the present invention.

FIG. 8 is an example of a screen of the GUI of an embodiment of the present invention where a user can specify spatial proximity settings for notifications (by the program code).

FIG. 9 is an example of the client device displaying a notification generated by the program code in some embodiments of the present invention.

FIG. 10 illustrates a screenshot depicting location elements used in a notification process of the program code in some embodiments of the present invention.

FIG. 11 depicts one embodiment of a computing node upon which various aspects of some embodiments of the present invention can be implemented.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure.

The terms software and program code are used interchangeably throughout this application and can refer to logic executed by both hardware and software. Components of the system that can be utilized to execute aspects of embodiments of the present invention may include specialized hardware, including but not limited to, an FPGA and a GPU (graphics professor unit). Additionally, items denoted as processors may include hardware and/or software processors or other processing means, including but not limited to a software defined radio and/or custom hardware.

As discussed above and understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code includes a program/utility, having a set (at least one) of program modules, stored in a memory.

As understood by one of skill in the art, for simplicity of illustration, a mobile application is illustrated in certain of the figures, but any geospatially aware web-enabled device could be used in place of mobile application for the described examples or in concert with the mobile application, as could any equivalent device known to one of skill in the art.

Embodiments of the present invention include a computer-implemented method, a computer program product, and a computer system where program code executing on at least one processors utilizes satellite derived geospatial product(s) (i.e., an observation that can be related to a given point(s) or region(s) on the Earth—such as the location of a lightning flash or wildfire) combined with Geographic Information System (GIS)/Geospatial Database frameworks and/or platforms to facilitate user proximity calculations to satellite events and based on these calculations, sends notifications to users in real-time to near real-time (e.g., via push notification, text message, and/or in mobile application alerts, also referred to as user notifications). Program code in embodiments of the present invention notifies users (e.g., on web-enabled computing devices) based on a current location of a user and proximity of the user to a given event indicated by the satellite data (e.g., lightning events, fires, air quality, and other hazards). Satellite-based notification systems represent improvements over systems with alerts based on ground networks for many reasons discussed herein. However, using the example of lightning discussed above, satellite based total lighting observations measure lightning flashes very differently than ground networks (light emitted through a cloud by a lighting flash) and thus, by utilizing the different measures, embodiments of the present invention offer a new capability to observe the spatial extent of the lightning flashes and better notify users of potential risk.

Embodiments of the present invention are inextricably linked to computing. The weather data provided by the program code in embodiments of the present invention, as explained and illustrated herein, are reliant upon communications between various computing devices and satellite derived geospatial products combined with Geographic Information System (GIS)/Geospatial Database frameworks. Through this communication and utilization of data, program code can provide real-time or near real-time alerts to users, who can avoid hazards based on the timing of these alerts. The computing framework of embodiments of the present invention enables the immediacy of the alerts as well as provides the data that is utilized to determine, by the program code, that an alert should be provided. Additionally, embodiments of the present invention include aspects that are additional elements that are a practical application; the purpose of embodiments of the present invention is to provide more accurate alerts given the shortcomings of weather alerts and weather data that is provided to individuals, via applications, that are based on data from ground networks. Embodiments of the present invention provide alerts based on satellite derived geospatial products. In order to provide accurate alerts within timing that is useful to a user, as explained herein, the hardware and software of embodiments of the present invention is configured to accommodate the timing and accuracy requirements of the user. For example, as explained herein, certain embodiments of the present invention include a server-side computing architecture to provide a higher reliability of notifications in specific use cases, including but not limited to, when the user is not actively using the user interface generated by the program code on the user's computer device (e.g., the screen is sleeping or the user is actively using a different application on the device such that the application is being run in the background). The server-side architecture enables access to data from which the program code generates alerts more frequently than the native devices provide, making the notification system more reliable, for example, by retaining a user's last known location (e.g., as a token). Without the server-side notification system, the device itself could only pull location information at intervals, which would slow the ability of the program code to alert the user to imminent weather events.

Embodiments of the present invention represent a practical application because as discussed herein, program code executing on one or more processors in some embodiments of the present invention determines that a user location (user device location) is within given proximity criterion (e.g., a specified distance away from a given satellite derived product/event) and based on this determination, the program code provides the user with a web-enabled notification that alerts the user of an event/hazard. The program code in embodiments of the present invention enables a real-time to near real-time notification to a user within the proximity of a given satellite derived product/event, which can be referred to as environmental intelligence. The end user can be a single or multiple geospatially enabled web device with or without a human observer in the loop. The utilization of aspects of some embodiments of the present invention by outdoor enthusiasts (in a non-limiting manner) practical applications of aspects of some embodiments of the present invention. For example, outdoor enthusiasts such as mariners in boats can utilize aspects of some embodiments of the present invention to receive timely alerts to lightning events in a given proximity to their locations (especially in cases where users are in a potential lightning-risk area and are unaware of the danger—as lightning can strike 10+ miles from a storm). Similarly, satellite derived fire detection products are critical to inform decision makers of possible wildfires in remote and urban areas. Providing geospatially aware notifications (environmental intelligence) to outdoor enthusiast users directly in proximity to these events can significantly contribute (positively) to the users' situational awareness, safety, and decision making.

Embodiments of the present invention provide significant advantages over existing mobile weather applications at least because the utilization of satellite data in place of data from ground networks (as is common to existing weather applications) eliminates certain limitations of the ground networks which in turn, limit the efficacy of the existing mobile weather applications. Many of the alert systems established today are via ground instrument networks. Satellite derived products combined with mobile applications and/or geospatial web-enabled technology offer a new mechanism to notify users of environmental hazards or other events of interest in their proximity in real-time to near real-time. At a basic level, satellite data is of the planet (both land and sea) while ground networks are more limited due to the logistics of deployment. For example, while lighting ground network data is passive electrical and radio frequency observations, satellite derived total lightning data provides new and unique monitoring capabilities over both land and ocean. For example, total lightning flashes observed from a geostationary orbit provide a new capability to observe lightning similar to how a human observer would from view if the human were in space. This type of visibility to environmental hazards is not possible with data from ground networks. Thus, satellite data provides a new and unique source of environmental intelligence data that is persistent and reliable. Aspects of embodiments of the present invention therefore provide improved situational awareness, which in certain situations, can save lives. For example, the program code in embodiments of the present invention can provide warnings based on satellite derived lightning detection risk-areas and hotspots, which provides the users within predefined proximities of these events/areas/risks, with an early warning of possible wildfires. In some instances, such as wildfires, these events may be reported to local officials from human observers, satellite derived observations, and in some cases limited point-based ground sensors. Often wildfires (for example) are reported to a community via news outlets, but the exact wildfire location(s) can be challenging to convey to the public, especially in the early stages of an event. By providing a notification based on a user's location and the user's proximity to an event, program code in embodiments of the present invention provides actionable intelligence to ensure safety and understanding a better understanding of situational awareness. Satellite data can be critical in these early stages of wildfire development as they can observe hotspots (location, intensity, and most importantly spatial extent) in real-time. In contrast, ground networks for lightning provide primarily a point-based observation of lightning flashes. Since, lightning can and does travel many miles from its point of origin (these flashes can also come to ground) the ground network data is limited in the assessment of the spatial extent of the flash. Thus, satellite based total lighting observations measuring lightning flashes very differently than ground networks (light emitted through a cloud by a lighting flash) and offers a new capability to observe the spatial extent of the lightning flashes and better notify users of potential risk. Thus, the data flow of the system and the unique combination of real-time to near real-time satellite derived products, web-enabled mobile applications and technology, and geospatial databases and geospatial data processing, enables the program code in embodiments of the present invention to inform users of possible environmental hazards or other predefined satellite derived events of interest.

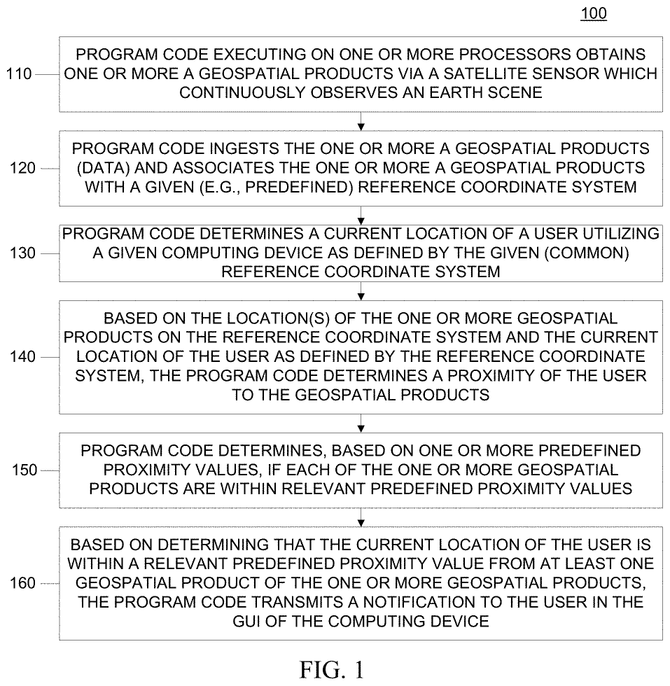

FIG. 1 is a workflow 100 that provides a general overview of certain aspects of some embodiments of the present invention. Specific functionality of various aspects is described in more detail in other figures herein. In embodiments of the present invention, program code executing on one or more processors notifies a user, based on generating a graphical user interface (GUI) on a computing device based on a current location of a user and the proximity of a user to a given event, as determined by the program code. As stated above, the program code can generate the notification via push notification, text message, and/or in mobile application alerts. In an embodiments of the present invention, program code executing on one or more processors obtains one or more a geospatial products via a satellite sensor which continuously observes an Earth scene (110). The program code ingests the one or more geospatial products (data) and associates the one or more geospatial products with a given (e.g., predefined) reference coordinate system (120). The program code determines a current location of a user utilizing a given computing device as defined by the given (common) reference coordinate system (130). The aspects in FIG. 1 are illustrated as being linear for ease of understanding. However, in some embodiments of the present invention, the program code determines the location of the user and/or the computing device asynchronously and/or in parallel with obtaining and/or ingesting the geospatial products. In some embodiments of the present invention, the program code (e.g., utilizing a web-enabled geospatial database) determines a user location through user input, inputs from a mobile device/application executing on a user computing device, web-enabled geospatial technologies executing on the computing device (e.g., location-based services (LBS) using real-time geo-data from the mobile device or smartphone), and/or an existing location device or location services executing on the computing device of the user being located (e.g., accelerometer, gyroscope, and/or motion sensor).

Based on the location(s) of the one or more geospatial products on the reference coordinate system and the current location of the user as defined by the reference coordinate system, the program code determines a proximity of the user (i.e., the user's current location) to the (derived) geospatial products (events of interest) (140). In various embodiments of the present invention, the user can configure, through a GUI, a proximity to a given derived product within which the user would like to be alerted. In some embodiments of the present invention, proximities are predefined. Thus, the program code determines, based on one or more predefined proximity values, if each of the one or more geospatial products are within relevant predefined proximity values (150). Based on determining that the current location of the user is within a relevant predefined proximity value from at least one geospatial product of the one or more geospatial products, the program code transmits a notification to the user in the GUI of the computing device (160). In some embodiments of the present invention, the program code generates the GUI, as the program code could be executing in the background on the computing device and based on determining that an alert should be transmitted, the program code activates the GUI such that it is no longer running as a background application and becomes a foreground application executing on the computing device of the user.

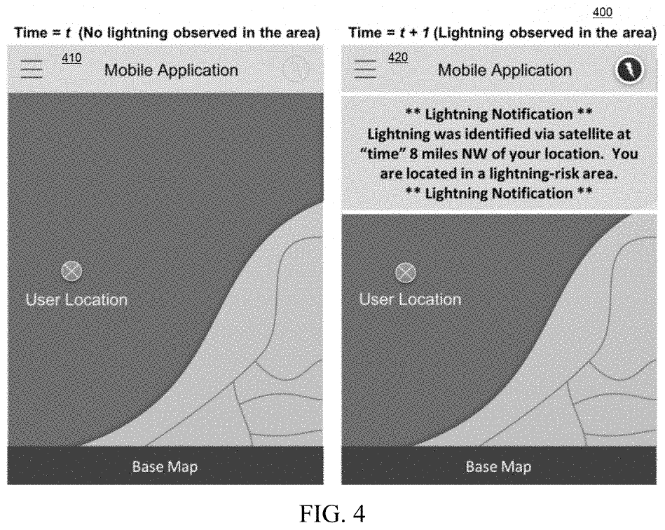

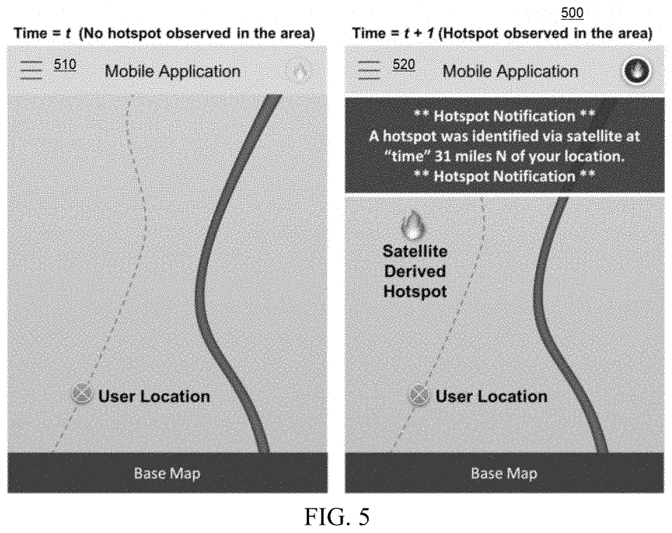

As discussed above, two practical applications for embodiments of the present invention are for warning users that they are within a given (problematic) proximity of a lightning strike and/or a wildfire. Thus, as illustrated in FIG. 1, the notification (160) provided by the program code to the user can be a warning when the user is within a given proximity (which can be a preconfigured distance value) of one or more of these geospatial products/events. For example, in some embodiments of the present invention, the program code warns a user of the user's proximity to a lightning strike (geospatial product) (e.g., FIG. 1, 160). FIG. 4 is an illustration of an example web-enabled geospatial mobile application 400 (generated by the program code in embodiments of the present invention) for notifying users they are within a satellite derived lightning risk-area based on their location. The left screenshot 410 shows at a time=0 (no lightning observed) shows the current user location in an open water area. The right screenshot 420 illustrates the mobile application user interface at time=time+1 (lightning observed in the area) with a user notification issued. In some embodiments of the present invention, the program code warns a user of the user's proximity to a satellite derived hotspot, likely a wildfire (geospatial product) (e.g., FIG. 1, 160). FIG. 5 is an illustration of an example web-enabled geospatial mobile application 500 (generated by the program code) that notifies users when they are within the given (predefined) vicinity of a satellite derived hot-spot, based on their location. In FIG. 5, the left screenshot 510 illustrates the mobile application user interface at time=0 (no hotspot observed) showing the current user location in a remote area. The left screenshot 520 illustrates the mobile application user interface at time=time+1 (hotspot observed in the area) with a user notification issued by the program code. In some embodiments of the present invention, the program code can disseminate (e.g., broadcast) hotspot data to users within a given area in order to significantly aid in the safety and decision making of these users.

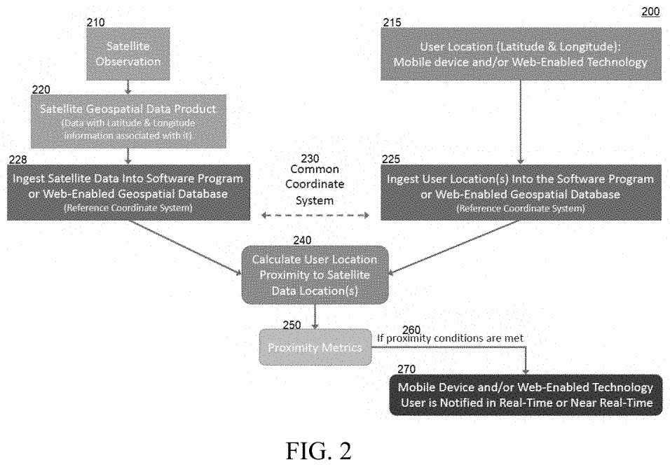

FIG. 2 is another workflow 200 that illustrates certain aspects of some embodiments of the present invention. As such, this workflow 200 illustrates how program code executing on one or more processors in embodiments of the present invention alerts and/or notifies an end user (e.g., multiple geospatially enabled web devices with or without a human observer) of the end user's proximity to environmental hazards and/or other events of interest based upon satellite derived products. As discussed above, in some embodiments of the present invention, program code executing on one or more processors on a server-side performs aspects of the present invention. Thus, in some embodiments of the present invention, the GUI and/or other alert mechanism utilized by the program code at the end user is a thin client application generated by the program code at the one or more servers communicatively couples to the end user (e.g., client). Additionally, for ease of understanding, in this workflow 200, certain aspects performed by the program code are discussed in terms of different modules. The representation of different aspects as different modules represents a non-limiting example of how various functionality can be distributed in an implementation of the invention and is not meant to suggest any limitations to how implementations of the software component(s) present invention can be configured.

Referring to FIG. 2, in some embodiments of the present invention, one or more satellite sensors observe an Earth scene (210). The program code executing on the one or more servers and/or program code in a system (e.g., module) communicatively coupled to the servers obtains the Earth scene and produces one or more geospatial product(s) (i.e., observations that can be related to a given point(s) or region(s) on the Earth, including but not limited to a location of a lightning flash and/or a location of a wildfire) (220). Program code comprising a software program and/or web-enabled geospatial database (e.g., another module) ingests the geospatial products and associates this satellite derived data (i.e., geospatial products) into a given reference coordinate system (228).

In the embodiment illustrated in FIG. 2, at the same time or close to the same time that the program code obtains a user location (215). In some embodiments of the present invention, program code comprising a software program and/or web-enabled geospatial database obtains a user location(s) from program code comprising a mobile device/application and/or web-enabled geospatial technology (associated with an end user) and the program code of the software program and/or web-enabled geospatial database determines an end user location (225) and interpolates this value such that it is in the same common coordinate reference system as the one or more geospatial product(s) (230).

Based on the end user location and the satellite data product event location(s) (i.e., the locations of the one or more geospatial product(s)), the program code of the software program calculates a proximity of the end user location to the locations of the one or more satellite derived products/events of interest (240). The program code determines whether predefined proximity conditions are met by the distances between the end user location and the locations of each of the one or more geospatial product(s) (250). Based on determining that the end user's location is within the predefined proximity conditions (e.g., a given proximity criterion that is a specified distance away from a given satellite derived product/event) (260), the program code generates a notification and transmits the notification (e.g., alert) to the mobile device/application and/or web-enabled geospatial technology (270). The transmission of this alert can include the program code generating an interface on the mobile device/application and/or web-enabled geospatial technology to provide a real-time to near real-time notification to the end user. The notification alerts the end user that the end user is in the predefined proximity of a given satellite derived product/event. The program code thus provides the end user with environmental intelligence.

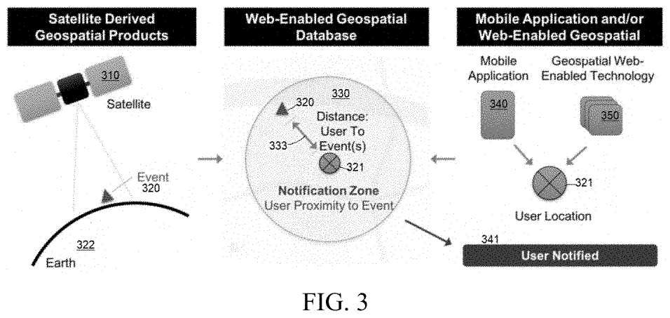

FIG. 3 is an illustration of a technical environment 300 into which aspects of some embodiments of the present invention can be implemented. The technical environment 300 also illustrated certain aspects of the data flow between various elements. As illustrated in FIG. 3, in the non-limiting example of a technical environment 300, program code executing on at least one processor (the program code, in one example, comprising a geospatial database) obtains data in the form of one or more satellite derived geospatial products from a satellite 310 observing an Earth scene 322, which includes a geospatial product, a satellite derived event 320. The program code (comprising the geospatial database 330) obtains a user location 321 one or more of a mobile application 340 and/or web-enabled geospatial technology 350 and retains the location 321 in the geospatial database 330. The program code calculates a geospatial conditional metric 333 between the satellite derived event 320 and the user location. The program code notifies the user, with a notification 341, via the mobile application 340 (and/or another mobile application) that notification criteria was met. As aforementioned, in some embodiments of the present invention, end user is a single or multiple geospatially enabled web device with or without a human observer in the loop.

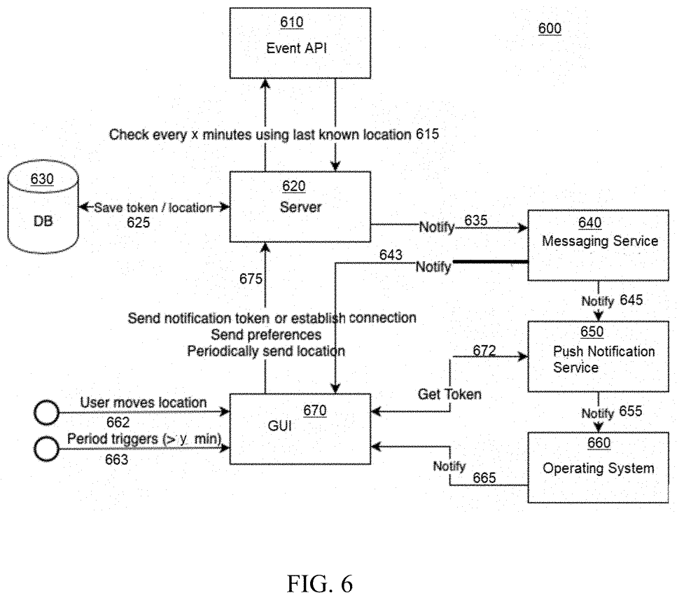

FIG. 6 is a more detailed combination workflow and technical environment 600 that further illustrates certain aspects discussed in FIGS. 1-3, in accordance with some embodiments of the present invention. FIG. 6 illustrates the aforementioned server-side architecture, with program code executing on a server 620. Although only a single server 620 is depicted in FIG. 6, this server 620 can represent one or more servers, both one or more virtual and/or physical resources, including those is a distributed computing environment, including but not limited to a cloud computing environment. The program code is executed on the server 620 because the server-side architecture provides a higher reliability of notifications in specific use cases, especially when the user is not actively using the GUI 670 (e.g., screen sleeping or using a different application on a device executing the GUI 670 (as well as a mobile operating system 660)) and the GUI 670 is being run on the mobile operating system 660 in the background. Embodiments of the present invention that do not utilize the server-side architecture of FIG. 6 can potentially limit the notification system to the mobile device location notification checks whenever the user moves past a threshold (662) or “every so often” (e.g., greater than y min 663, where y, in one example, is equal to about 15 minutes), when user is not actively using the GUI 670 (the application). The program code executing on the server 620 on the server-side architecture saves (625) the user's last known token/location to a database 630, it enables access to an event application programming interface (API) 610 (e.g., a lightning API, a hotspot API, etc.) more frequently than the native devices would provide, making the notification system more reliable. As an example, in some embodiments of the present invention, as the event (e.g., lightning, hotspot, etc.) data is refreshed by the program code (e.g., new observations are entered into the system) the user's last known location can be used to compute the proximity calculations, to ensure more reliability in the process. Without these aspects, the program code could only check the location (663) no less than every y (e.g., 15) minutes in this case. In the embodiment depicted in FIG. 6, the program code executing on the server 620 checks the last know location of the user (615) every x minutes, where x is less than y. In one example, x is 5 and y is 15.

Referring to FIG. 6, in an embodiment of the present invention, the program code executing on the server 620 obtains a location from a client device (in this example, via a GUI 670 executing on the client device) periodically (675). The program code saves the location as a token (625) in a database 630. The client obtains its location information via the GUI 670 based on checking location (using existing location services on the client device) at intervals triggered by the lapse of periods of greater than y (e.g., ˜15) minutes (663) and/or when the client device determines (e.g., via gyroscope, accelerometer, location services, etc.) that the client device has moved a threshold amount (662), thus changing the location.

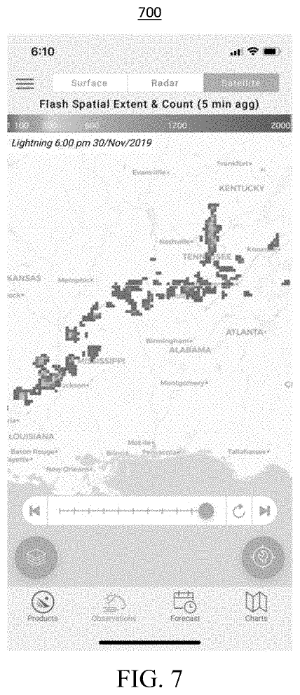

The program code obtains geospatial products (events) from an event API 610, which obtains this data from sensors comprising a satellite. One satellite from which data can be obtained by the program code, via the event API 610, is GOES-16. FIG. 7 illustrates data 700 from the National Oceanic and Atmospheric Administration (NOAA) Geostationary Lightning Mapper (GLM) on the GOES-16 satellite, as displayed in a screen of a GUI 670 (FIG. 6) of an embodiment of the present invention. Returning to FIG. 6, the program code executing of the server 620 checks the geospatial products utilizing the last known location every x (e.g., 5) minutes (615). The program code can provide this location information to the event API 610 every x minutes based on obtaining a token holding this information from the database 630.

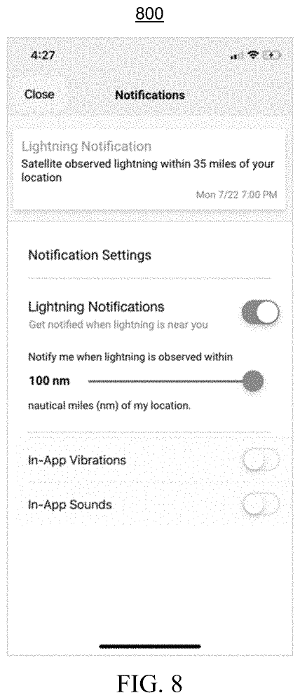

When the program code executing on the server 620 determines that one or more geospatial products (satellite derived events) are within a predefined proximity of a last known location of the user, the program code notifies the user of this issue (635), as illustrated in FIG. 6 and as described in the paragraphs that follow. However, in some embodiments of the present invention, a user can define the proximity settings in the GUI 670. FIG. 8 is an example of a screen 800 of the GUI 670 (FIG. 6) where a user can specify spatial proximity settings for notifications.

Returning, to FIG. 6, when the program code executing on the server 620 determined that one or more geospatial products (satellite derived events) are within a predefined proximity of a last known location of the user, to notify the user, the program code notifies (635) a messaging system 640 (compatible with the client device), which can include an existing messaging system. In some embodiments of the present invention, the program code notifies an instance of Firebase Cloud Messaging (FCM), which is a cross-platform cloud solution for messages and notifications for Android, iOS, and web applications. This messaging system 640 is compatible with different versions of the GUI 670, which can vary depending upon the client device upon which the GUI 670 is executed. In some embodiments of the present invention where the client device is an Android executing the GUI 670, the messaging system 640 sends a notification to the GUI 670 (643). In an embodiment of the present invention where the client device is an Apple device, for example, the messaging system 640 sends a notification to a push notification service 650 (645), which can also be utilized if the user is not actively utilizing the GUI 670 as the application is running in the background. The push notification service 650 can also obtain a token from the GUI 670 and/or provide a notification token to the GUI 670. In some embodiments of the present invention, the push notification service 650 notifies the operating system 660 of the client device (665). In some embodiments of the present invention, the program code utilizes an existing push notification service 650, including but not limited to Apple Push Notification (APN) service, a platform notification service that sends notification data to applications installed on Apple devices. The notification information sent in embodiments of the present invention can include, but is not limited to, badges, sounds, newsstand updates, and/or custom text alerts. As illustrated in FIG. 6, in some embodiments of the present invention, the operating system 660 of the client device, which can include but is not limited to, iOS and/or another mobile operating system, can provide the notification to the GUI 670 (665).

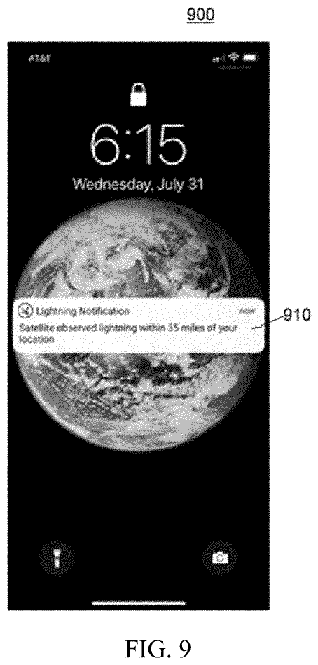

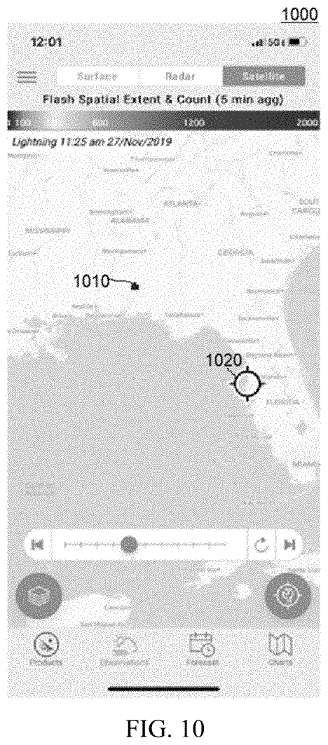

FIG. 9 is an example of the client device 900 with a notification 910 generated by the program code in some embodiments of the present invention. In this example, the notification is a push notification as the GUI 670 (FIG. 6) is not being executed in the foreground. Thus, in some embodiments of the present invention, the notification system occurs in the background to users, however FIG. 10 illustrates a screenshot 1000 depicting location elements 1010, 1020 used in a notification process of the program code. The screenshot 10000 include a depiction of observed lightning 1010 and a user location 1020. In some embodiments of the present invention, if lightning is observed within the user specified proximity setting to their current location, the program code sends a notification.

Embodiments of the present invention include a computer-implemented method, a computer program product, and a computer system, where program code executing on one or more servers obtains, via a satellite sensor which continuously observes an Earth scene, one or more a geospatial products, where each geospatial product comprises a satellite derived event. The program code associates each of the one or more geospatial products with a location defined by a reference on a coordinate system. The program code, contemporaneously with obtaining the geospatial products, determines, based on a token obtained by the one or more processors from a client device, a current location of the client device, where the current location is defined by a given reference on the coordinate system. The program code generates, based on the current location and the location associated with each of the one or more geospatial products, proximity values, where each proximity value indicates a proximity of the current location to a geospatial product of the one or more geospatial products. The program code determines if any of the proximity values are within one or more predefined proximity thresholds, wherein the proximity thresholds are stored on a memory device communicatively couples to the one or more processors executing the program code. Based on determining that at least one of the proximity thresholds is met or exceeded by at least one proximity value of the proximity values, the program code generates a notification for the client device comprising an alert regarding the one or more geospatial products associated with the at least one proximity value. The program code transmits the alert to the client device and generates an instant alert in a graphical user interface on the client device, where the instant alert visually disrupts any application displaying on the client device (including a screensaver on a locked screen).

In some embodiments of the present invention, the program code obtains, from the client device, the token. Obtaining the token can include: the program code establishing a connection between the client device and one or more servers comprising the one or more processors, the program code receiving, periodically, from the client device, via the connection, location data comprising a current location of the client device, and the program code storing the token in the memory device.

In some embodiments of the present invention, the client device obtains the location data comprising the current location of the client device from location services executing on the client device, where the location services obtain the location based on the passage of an event selected from the group consisting of: passage of a set interval and movement of the client device beyond a given distance.

In some embodiments of the present invention, the program code obtaining, via the satellite sensor, the one or more geospatial products, further comprises: the program code connecting to an application programming interface in communication with the satellite sensor, where the application programming interface converts observational data collected by the satellite sensor based on continuously observing the Earth scene, to the one or more geospatial products, the program code requesting, from the application programming interface, the one or more geospatial products, and the program code, based on the requesting, obtaining, the one or more geospatial products.

In some embodiments of the present invention, the program code transmitting the alert to the client device comprises the program code utilizing a middleware system or service to provide the alert to the client device, the middleware system or service selected from the group consisting of: a messaging service, a push notification service, and an operating system. The middleware system or service can include the operating system and the operating system can be executing on the client device.

In some embodiments of the present invention, the proximity thresholds are configured by a user through the graphical user interface on the client device.

In some embodiments of the present invention, the one or more geospatial products are selected from the group consisting of: lightning and a hotspot.

In some embodiments of the present invention, the program code determining the current location of the client device further comprises the program code continuously obtaining the token from the client via one or more servers comprising the one or more processors, at regular intervals. The passage of the event can be a longer time period than an interval of the regular intervals.

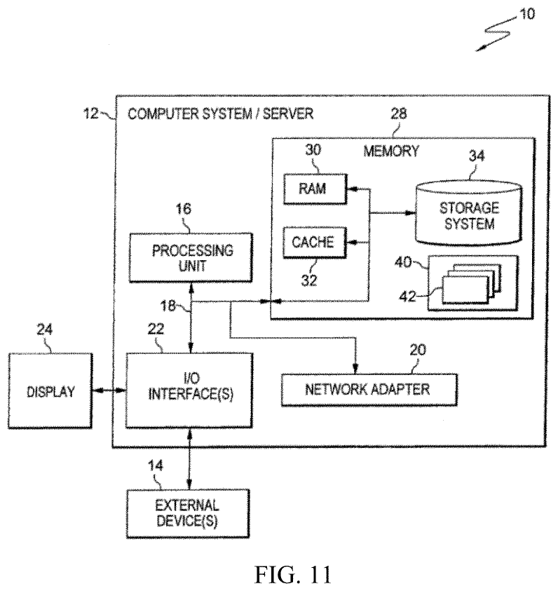

Referring now to FIG. 11, a schematic of an example of a computing node, which can be communicatively coupled to elements of the system described to obtain data is shown. Computing node 10 is only one example of a suitable computing node and is not intended to suggest any limitation as to the scope of use or functionality of embodiments of the invention described herein. An example of one or more computing nodes utilized in embodiments of the present invention, which can include cloud computing nodes, is server 620 (FIG. 6). However, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The components of computer system/server 12, which can be a cloud computing node, may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

What is claimed is:

1. A computer-implemented method, comprising:
obtaining, by one or more processors, via a satellite sensor which continuously observes an Earth scene, one or more a geospatial products, wherein each geospatial product comprises a satellite derived event;
associating, by the one or more processors, each of the one or more geospatial products with a location defined by a reference on a coordinate system;
contemporaneously with obtaining the geospatial products, determining, by the one or more processors, based on a token obtained by the one or more processors from a client device, a current location of the client device, wherein the current location is defined by a given reference on the coordinate system;
generating, by the one or more processors, based on the current location and the location associated with each of the one or more geospatial products, proximity values, wherein each proximity value indicates a proximity of the current location to a geospatial product of the one or more geospatial products;
determining, by the one or more processors, if any of the proximity values are within one or more predefined proximity thresholds, wherein the proximity thresholds are stored on a memory device communicatively couples to the one or more processors;
based on determining that at least one of the proximity thresholds is met or exceeded by at least one proximity value of the proximity values, generating a notification for the client device comprising an alert regarding the one or more geospatial products associated with the at least one proximity value;
transmitting, by the one or more processors, the alert to the client device; and
generating, by the one or more processors, an instant alert in a graphical user interface on the client device, wherein the instant alert visually disrupts any application displaying on the client device.

2. The computer-implemented of claim 1, further comprising:
obtaining, by the one or more processors, from the client device, the token.

3. The computer-implemented method of claim 2, wherein obtaining the token comprises:
establishing, by the one or more processors, a connection between the client device and one or more servers comprising the one or more processors;
receiving, by the one or more processors, periodically, from the client device, via the connection, location data comprising a current location of the client device; and
storing, by the one or more processors, the token in the memory device.

4. The computer-implemented method of claim 3, wherein the client device obtains the location data comprising the current location of the client device from location services executing on the client device, wherein the location services obtain the location based on the passage of an event selected from the group consisting of: passage of a set interval and movement of the client device beyond a given distance.

5. The computer-implemented method of claim 1, wherein obtaining, via the satellite sensor, the one or more geospatial products, further comprises:
connecting, by the one or more processors, to an application programming interface in communication with the satellite sensor, wherein the application programming interface converts observational data collected by the satellite sensor based on continuously observing the Earth scene, to the one or more geospatial products;
requesting, by the one or more processors, from the application programming interface, the one or more geospatial products; and
based on the requesting, obtaining, by the one or more processors, the one or more geospatial products.

6. The computer-implemented method of claim 1, wherein transmitting the alert to the client device comprises utilizing a middleware system or service to provide the alert to the client device, the middleware system or service selected from the group consisting of: a messaging service, a push notification service, and an operating system.

7. The computer-implemented method of claim 5, wherein the middleware system or service comprises the operating system and wherein the operating system is executing on the client device.

8. The computer-implemented method of claim 1, wherein the proximity thresholds are configured by a user through the graphical user interface on the client device.

9. The computer-implemented method of claim 1, wherein the one or more geospatial products are selected from the group consisting of: lightning and a hotspot.

10. The computer-implemented method of claim 4, wherein determining the current location of the client device further comprises continuously obtaining the token from the client via one or more servers comprising the one or more processors, at regular intervals.

11. The computer-implemented method of claim 10, wherein the passage of the event is a longer time period than an interval of the regular intervals.

12. A computer program product comprising:
a computer readable storage medium readable by one or more processors and storing instructions for execution by the one or more processors for performing a method comprising:
obtaining, by the one or more processors, via a satellite sensor which continuously observes an Earth scene, one or more a geospatial products, wherein each geospatial product comprises a satellite derived event;
associating, by the one or more processors, each of the one or more geospatial products with a location defined by a reference on a coordinate system;
contemporaneously with obtaining the geospatial products, determining, by the one or more processors, based on a token obtained by the one or more processors from a client device, a current location of the client device, wherein the current location is defined by a given reference on the coordinate system;
generating, by the one or more processors, based on the current location and the location associated with each of the one or more geospatial products, proximity values, wherein each proximity value indicates a proximity of the current location to a geospatial product of the one or more geospatial products;
determining, by the one or more processors, if any of the proximity values are within one or more predefined proximity thresholds, wherein the proximity thresholds are stored on a memory device communicatively couples to the one or more processors;
based on determining that at least one of the proximity thresholds is met or exceeded by at least one proximity value of the proximity values, generating a notification for the client device comprising an alert regarding the one or more geospatial products associated with the at least one proximity value;
transmitting, by the one or more processors, the alert to the client device; and
generating, by the one or more processors, an instant alert in a graphical user interface on the client device, wherein the instant alert visually disrupts any application displaying on the client device.

13. The computer program product of claim 12, the method further comprising:
obtaining, by the one or more processors, from the client device, the token.

14. The computer program product of claim 13, wherein obtaining the token comprises:
establishing, by the one or more processors, a connection between the client device and one or more servers comprising the one or more processors;
receiving, by the one or more processors, periodically, from the client device, via the connection, location data comprising a current location of the client device; and
storing, by the one or more processors, the token in the memory device.

15. The computer program product of claim 14, wherein the client device obtains the location data comprising the current location of the client device from location services executing on the client device, wherein the location services obtain the location based on the passage of an event selected from the group consisting of: passage of a set interval and movement of the client device beyond a given distance.

16. The computer program product of claim 12, wherein obtaining, via the satellite sensor, the one or more geospatial products, further comprises:
connecting, by the one or more processors, to an application programming interface in communication with the satellite sensor, wherein the application programming interface converts observational data collected by the satellite sensor based on continuously observing the Earth scene, to the one or more geospatial products;
requesting, by the one or more processors, from the application programming interface, the one or more geospatial products; and
based on the requesting, obtaining, by the one or more processors, the one or more geospatial products.

17. The computer program product of claim 12, wherein transmitting the alert to the client device comprises utilizing a middleware system or service to provide the alert to the client device, the middleware system or service selected from the group consisting of: a messaging service, a push notification service, and an operating system.

18. The computer program product of claim 17, wherein the middleware system or service comprises the operating system and wherein the operating system is executing on the client device.

19. The computer program product of claim 12, wherein the proximity thresholds are configured by a user through the graphical user interface on the client device.

20. A system comprising:
a memory;
one or more processors in communication with the memory;
program instructions executable by the one or more processors via the memory to perform a method, the method comprising:
obtaining, by the one or more processors, via a satellite sensor which continuously observes an Earth scene, one or more a geospatial products, wherein each geospatial product comprises a satellite derived event;
associating, by the one or more processors, each of the one or more geospatial products with a location defined by a reference on a coordinate system;
contemporaneously with obtaining the geospatial products, determining, by the one or more processors, based on a token obtained by the one or more processors from a client device, a current location of the client device, wherein the current location is defined by a given reference on the coordinate system;
generating, by the one or more processors, based on the current location and the location associated with each of the one or more geospatial products, proximity values, wherein each proximity value indicates a proximity of the current location to a geospatial product of the one or more geospatial products;
determining, by the one or more processors, if any of the proximity values are within one or more predefined proximity thresholds, wherein the proximity thresholds are stored on a memory device communicatively couples to the one or more processors;
based on determining that at least one of the proximity thresholds is met or exceeded by at least one proximity value of the proximity values, generating a notification for the client device comprising an alert regarding the one or more geospatial products associated with the at least one proximity value;
transmitting, by the one or more processors, the alert to the client device; and
generating, by the one or more processors, an instant alert in a graphical user interface on the client device, wherein the instant alert visually disrupts any application displaying on the client device.
